(19) United States
(12) Patent Application Publication
(10) Pub. No.: US 2005/0154475 A1
(43) Pub. Date: Jul. 14, 2005

(54) Control device

(76) Inventors: Thomas Forchert, Stuttgart (DE); Juergen Luka, Tamm (DE); Wolfgang Vieweger, Aichtal-Aich (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/497,604

(22) PCT Filed: Oct. 18, 2002
(86) PCT No.: PCT/EP02/11681

(30) Foreign Application Priority Data
Dec. 4, 2001 (DE) 101 59 480.1

(51) Int. Cl. G05B 11/01

(52) U.S. Cl. 700/20; 700/19

(57) ABSTRACT

A control device for controlling a system having a processor for executing control programs, memory means for storing data and control programs, and interface modules which can be used to transfer control instructions to actuators or to further control devices is connected to other control devices by means of a data bus. The control device includes a plurality of cells of the same type, each of which has a piece of reconfigurable hardware and peripheral modules. These cells can be reconfigured by configuration data, so that hardware connections for each cell can be adjusted to adapt to a desired control process. One or more cells together form a processor and/or interface modules.

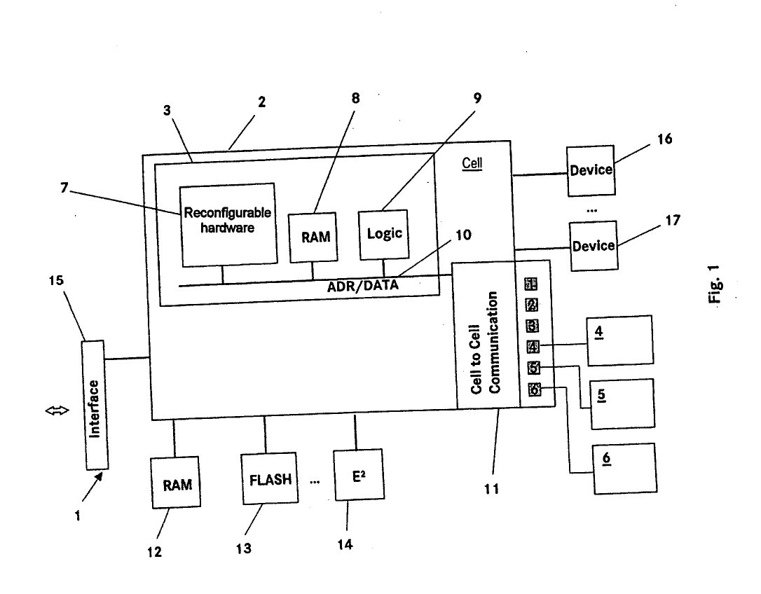

### BACKGROUND AND SUMMARY OF THE INVENTION

This application claims the priority of German patent document 101 59 480.1, filed 4 Dec. 2001 (PCT International Application No. PCT/EP02/11681, filed 18 Oct. 2002), the disclosure of which is expressly incorporated by reference herein.

The invention relates to an equipment control device having a processor for executing control programs, a memory for storing data and control programs, and having interface modules which are used to transfer control instructions to actuators or to further control devices, wherein the control device is connected to other control devices by means of a data bus.

German patent document DE 197 50 662 A1 discloses a standard computer unit having a microprocessor, for performing various control processes within a vehicle control unit, such as engine control. The microprocessor is scalable, in that each microprocessor has a plurality of microprocessor variants with different powers for the same connection pin configuration, so that a suitable microprocessor can be used in the control unit according to the power requirement. If higher performance becomes necessary for an application in transport means, simple processor exchange—without altering the peripheral components in the process—is intended to insert a faster microprocessor. The advantage of such a standard computer unit is that it is not necessary to use a different control unit in the transport means for each control application, but rather the same hardware can be used even for more complex control tasks merely by substituting a more powerful processor. Depending on the application, a different piece of control software then runs on the standard computer unit.

In addition, various applications with reconfigurable hardware are known. Reconfigurable hardware is understood to mean a hardware module which comprises a number of individual memory cells that can be electrically conductively connected in arbitrary manner. In this way, it is possible to configure logic modules, memory means and adders, for example, with the module remaining installed on the board. If other modules are required, the hardware can be reconfigured, which means that the same hardware forms a memory array, for example, by connecting the memory cells to one another differently.

One example of reconfigurable hardware in use today is field programmable gate arrays (FPGA), which are also already in practical use for applications in connection with PC systems. As an example, reference is made at this juncture to the disclosure of European patent documents EP 177261 B1, EP 463026 B1, and EP 642094 A2, and to U.S. Pat. No. 5,570,039. Use in networked control units, as are customary in transport means, has not been given any consideration to date in the prior art.

It is an object of the present invention to provide a networked device for controlling machines or transport means, which can be used as an alternative to the scalable standard processor which is already known.

This and other objects and advantages are achieved by the control device according to the invention, which has a plurality of cells of the same kind, each cell having a piece of reconfigurable hardware and also a cell communication unit. The cells can be reconfigured by configuration data, so that each cell is adjusted in terms of its hardware connections for the control process, and one or more cells together form a processor and/or peripheral modules.

In one embodiment of the invention, the control device is intended to be used within a machine or a transport means together with further control devices which are networked to one another by means of a respective data bus or other lines. In contrast to conventional systems, in which a new piece of software is merely loaded, the use of a piece of reconfigurable hardware, for example a field programmable gate array (FPGA), also allows the hardware configuration of the existing reconfigurable hardware in a control unit to be altered. The fact that the device is made up of a plurality of cells of the same kind means that each cell can be reconfigured independently by configuration data. The cells are likewise networked to one another within the device, for example by an internal bus in the device. The device made up of the individual cells is then networked to further control units externally, as already described, by means of the data bus. The internal cellular design allows the device to be configured separately per cell, so that each cell can perform a dedicated control function. In this way, the device can replace the conventional tasks of a control unit either in part or in full.

According to another embodiment of the invention, the device is made up of cells which contain, as reconfigurable hardware, FPGAs, for example, which in turn comprise individual memory cells. The memory cells in the reconfigurable hardware are preferably provided on one chip and can be reconfigured by electronic signals, so that new internal connections in the memory cells are configured. If a different logic circuit becomes necessary, then the FPGA module can easily be reconfigured.

In contrast, the cells in the device are hardwired and each form a superordinate unit with tasks relating to a specific technology. A first cell can perform control tasks for the engine electronics, with a processor, a memory module and a cell communication unit being configured in the FPGA. A second cell can then drive the driver information system, to which end a logic adder and memory units are configured in the FPGA. In addition, the second cell may also contain a microcomputer and interface modules for the data bus, which are then provided as conventional electronic components.

One particular advantage of the invention is that a standard control device is produced which has independent reconfigurable cells that can be reconfigured in line with the control task using configuration data before they are used. In this case, it is possible to simulate existing control units in relation to their hardware forms, so that the device can be configured as a spare control unit, for example after a conventional microprocessor is no longer being produced by its manufacturer. In addition, this standard control device can also be used for control processes which do not justify the manufacture of a new conventional control unit, on account of a small quantity. However, the particular advantage of the invention is that the device for control can be in arbitrarily scalable form. That is, the cells may be in the form of single modules with the necessary peripheral area and, depending on requirements, may be coupled to an available interface on the internal bus in the device. This means that when a new system is used, for example a new driver information system, a further cell may be coupled to the device for control and may be reconfigured by downloading configuration data in a hardware description language.

Alternatively, the functions of a processor or of a driver unit can be downloaded onto the reconfigurable hardware using a hardware description language, so that a classical program (for example in C or Java) can be produced which can then be executed on this configured hardware. This allows the hardware in an existing motor vehicle to be upgraded by interfacing a new cell with reconfigurable hardware and the associated peripheral modules.

Preferably, the device has a firmly prescribed number of cells, with each cell having a piece of reconfigurable hardware as well as the required peripheral modules. The cells may be networked to one another by the internal bus and may be connected arbitrarily. The configuration data may indicate the necessary hardware configuration in the form of a hardware description language. To this end, a microcomputer area or an interface module may be simulated in hardware. However, it may also be possible to select, from the firmly prescribed number of cells provided on the board of the device, a subset which are then connected as appropriate using the configuration data. Increased processing power (i.e., the scaling of the processor) is then achieved by adding and reconfiguring further cells. The configuration data in the form of a hardware description language (HDL) can be transferred to the respective cell via a first interface for the device and via the internal interfaces, so that each cell can be configured separately or just selected cell groups can be configured. A database can then store a plurality of configuration data records, so that the hardware can be configured on the basis of the control processes required.

Each cell may be a separate component, with at least one piece of reconfigurable hardware and the peripheral modules being provided for networking the cells. Peripheral modules are, by way of example, interfaces for an internal data bus (connecting the cells to one another) in the device, timer and interrupt modules. In addition, a conventional microprocessor or microcontroller may then also be provided in each cell. The advantage of the invention is that the number of control units provided in the vehicle can be reduced by the scalable device. The hardware can be reconfigured, which means that a plurality of different control processes are also executed on a single control device. The invention allows a scalable standard control unit to be produced using reconfigurable hardware, and the associated software is loaded onto the hardware produced in this manner.

The hardware can be adjusted using reconfiguration by a hardware description language, in order to simulate particular hardware modules using FPGA modules. For simulation of a control unit's hardware, control functions can be represented directly as a hardware configuration, even without the microcontroller which is normally provided. The necessary processing power or the memory and peripheral modules required may be produced by configuring one or more cells and networking them to one another. The flexibility in the hardware configuration makes it possible to map a large number of vehicle functions within an device. The degree to which the individual cells are networked within the device is dependent on the complexity of the configured hardware or on the safety-related redundancy requirements. By way of example, safety can be enhanced by providing a further cell for checking a control process, and networking it to the previously required cells the internal bus.

In a preferred development of the invention, at least one of the cells is equipped with a piece of reconfigurable hardware which can perform the computation functions of a microcontroller. This means that the device may fully or partially replace a conventional control unit having a microcontroller. In this way, the reconfigurable hardware (for example an FPGA) can be configured by the hardware description language such that a computation process is simulated for a control function. The FPGA may produce an adder and multiplier elements, for example, in order to perform complex processing tasks. In a conventional control unit, this control function may then be omitted and moved to the outside; alternatively the conventional control unit may be omitted altogether.

Preferably, the cells in the device are configured by downloading a hardware description language, and each cell is configured to perform one or more specific control functions. For a higher processing requirement, the device can easily be scaled by adding and/or activating one or more additional cells using the hardware description language, so that the new cells can then execute additional processing tasks. The device for control is therefore particularly suitable for applications in small quantities when the processing power needs to have a particularly high level of adjustability. This includes, in particular, the spares requirement for control units or the subsequent addition of additional functions to a control unit which already exists. The additional function is then provided by means of the hardware description language in relation to the hardware required, so that the additionally downloaded software may be used on this configured hardware.

The control device according to the invention may be used, in particular, as a replacement control unit. In one embodiment of the invention, the cells are networked to one another by an internal optical or electrical data bus or a wireless interface, particularly a radio interface. In this case, reconfigurable hardware can be connected such that the peripheral modules in a cell can be programmed as an interface for the internal bus. In addition, each cell may also have an interface for the external data bus which connects together the control devices (i.e., the control units).

Other objects, advantages and novel features of the present invention will become apparent from the following detailed description of the invention when considered in conjunction with the accompanying drawings.

### BRIEF DESCRIPTION OF THE DRAWINGS

The single FIGURE shows an embodiment of a cell in the control device according to the invention, for controlling components in a motor vehicle.

### DETAILED DESCRIPTION OF THE DRAWINGS

As shown in the Figure, the device 1 for controlling components in a motor vehicle has a processor 2 for executing control programs which is made up of one or more cells 3, 4, 5, 6. Each cell 3, 4, 5, 6 has a piece of reconfigurable hardware 7, particularly an FPGA module, a memory unit 8 and a logic unit 9. The memory unit 8 and also the logic unit 9 form peripheral modules for the cell 3 which are provided for storing the data and control programs, and for providing the control instructions or for outputting the data to the internal data bus 10.

The internal data bus 10 is connected to a cell communication unit 11 which controls communication among the cells 3, 4, 5, 6 via the internal data bus 10. The cell communication unit 11 may in turn be made up of a piece of reconfigurable hardware. The device 1 for control has further memory units 12, 13 and 14, which are used, inter alia, to allow storage of configuration data that have been downloaded via the external interface 15, for example via a wireless interface or a data bus. Preferably, configuration data from another control device may be stored in the flash memory 13 via the interface 15, and these configuration data have a hardware description language which can be used for reconnecting the reconfigurable hardware 7. If the reconfigurable hardware 7 is an FPGA module, then the latter comprises a large number of memory cells which can be connected to one another differently by means of variable connecting lines. Depending on the connection pattern, the result is then a different hardware module. For example, an adder or a memory means or a logic module may be configured using the hardware description language.

In the reconfiguration process, the hardware description language is then respectively assigned to the cell 3, 4, 5, 6 in question, so that the latter is reconfigured in terms of its hardware. The interface 15 can then likewise be used to download the software as well and to store it in one of the memory modules 12, 13, 14, so that each cell 3, 4, 5, 6 is also assigned the corresponding software in order to allow a control process to be performed with the necessary functions.

Actuators and/or sensors 16, 17 are connected to the device 1 or directly to the cell 3 and are controlled by the device 1. By way of example, these are actuators such as electrically actuatable control valves which are used for engine control in motor vehicles. The sensor 16 detects data, for example the engine temperature or a rotation speed, which are required for carrying out the control process.

The device 1 for control is made up of a plurality of cells 3, 4, 5, 6 of the same kind which are connected to one another by means of the cell communication unit 11 and the internal data bus 10. The cells may be wired up flexibly for serial or parallel processing by the cell communication unit 11. This may also be done in this case using an FPGA module which can be programmed in terms of the connections. Each cell, 3, 4, 5, 6 or else just a particular cell communication unit are connected by means of the interface 15 to an external data bus having further control units within the transport means. To this end, various data bus, interfaces are required, for example a CAN interface or an interface for an optical data bus, which then connects the various control devices to one another. Each of the cells 3, 4, 5, 6 contains a cell communication unit 11 which may in turn be a piece of reconfigurable hardware itself.

The cellular design of the device 1 for controlling machines or transport means and of the reconfigurable hardware 7 allows different functions to be assigned to different cells 3, 4, 5, 6, according to a desired application. The cells, 3, 4, 5, 6 may be specialized in terms of the control functions, and scalability (i.e., the increase in processing power) may be implemented by retrospectively adding a further cell. The retrospective scalability (for example when an additional function must be controlled electronically in a motor vehicle) may be desired if a cell 3, 4, 5, 6 is retrospectively coupled to the cell communication unit 11 or if a particular number of cells 3, 4, 5, 6 are provided in the device 1 in redundant form from the outset and are retrospectively reconfigured again for increased processing power.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-9. (canceled)

10. A control device for controlling a system having a plurality of control units that are networked via a first data bus, each control unit having a processor for executing control programs, at least one memory unit for storing data and control programs, and an interface module which can be used to transfer the control instructions to actuators or to the further control units, wherein:
at least one of the control units includes a plurality of cells of the same type which cells are in the form of separate electronic elements having cell communication units;
the plurality of similar cells are networked to one another by a second, internal, data bus in the control device;
each cell has a piece of reconfigurable hardware with a multiplicity of networked memory cells that can be connected to one another in different ways by means of variably switchable connecting lines, and a cell communication unit;
the reconfigurable hardware in each cell can be reconfigured by configuration data, so that hardware connections of each cell can be adjusted to perform a particular desired control process;
a number of said cells together form a processor or peripheral modules in a control unit; and
further cells can be interfaced or retrospectively configured using an interface, in order to increase the processing power of the control unit.

11. A control device for controlling a system having a plurality of control units that are networked via a first data bus, each control unit having a processor for executing control programs, at least one memory unit for storing data and control programs, and an interface module which can be used to transfer the control instructions to actuators or to the further control units, wherein:
at least one of the control units includes a plurality of cells of the same type which cells are in the form of separate electronic elements having cell communication units;
the plurality of similar cells are networked to one another by a second, internal, data bus in the control device;
each cell has a piece of reconfigurable hardware with a multiplicity of networked memory cells that can be connected to one another in different ways by means of variably switchable connecting lines, and a cell communication unit;
the reconfigurable hardware in each cell can be reconfigured by configuration data, so that hardware connections of each cell can be adjusted to perform a particular desired control process;
a number of said cells together form a processor or peripheral modules in a control unit; and
the cells are configurable by downloading a hardware description language, with each cell simulating a subfunction of a conventional microcontroller in a control unit.

12. The control device as claimed in claim 10, wherein the control device has a fixed number of cells; and
the configuration data allow a subset of said cells to be selected and connected as appropriate for handling the particular control process.

13. The control device as claimed in claim 11, wherein:
the control device has a fixed number of cells; and
the configuration data allow a subset of said cells to be selected and connected as appropriate for handling the particular control process.

14. The control device as claimed in claim 10, wherein the configuration data have a hardware description language which describes a configuration option for the reconfigurable hardware, and which can be downloaded via an interface onto the device for control.

15. The control device as claimed in claim 11, wherein the configuration data have a hardware description language which describes a configuration option for the reconfigurable hardware, and which can be downloaded via an interface onto the device for control.

16. The control device as claimed in claim 10, wherein:
said memory units can store a plurality of configuration data records; and
the reconfigurable hardware can be configured on the basis of the particular control process.

17. The control device as claimed in claim 11, wherein:
said memory units can store a plurality of configuration data records; and
the reconfigurable hardware can be configured on the basis of the particular control process.

18. The control device as claimed in claim 10, wherein at least one of the cells is configurable to perform computation functions of a microcontroller, whereby the device can replace the microcontroller in a control unit.

19. The control device as claimed in claim 11, wherein at least one of the cells is configurable to perform computation functions of a microcontroller, whereby the device can replace the microcontroller in a control unit.

20. The control device as claimed in claim 10, wherein an occurrence of a higher processing requirement prompts at least one cell to be added or activated so that it can execute additional processing tasks.

21. The control device as claimed in claim 11, wherein an occurrence of a higher processing requirement prompts at least one cell to be added or activated so that it can execute additional processing tasks.

22. The control device as claimed in claim 10, wherein the device can be configured to accord with an existing control unit by downloading a hardware description language, whereby the device can be used as a replacement control unit.

23. The control device as claimed in claim 11, wherein the device can be configured to accord with an existing control unit by downloading a hardware description language, whereby the device can be used as a replacement control unit.

24. The control device as claimed in claim 10, wherein the second data bus is an optical data bus.

25. The control device as claimed in claim 11, wherein the second data bus is an optical data bus.
